(19) United States
(12) Patent Application Publication
(10) Pub. No.: US 2025/0337467 A1
(43) Pub. Date: Oct. 30, 2025

(54) METHOD AND DEVICE FOR DETECTING CHANNEL VARIATION, BASED ON AI MODEL IN WIRELESS COMMUNICATION SYSTEM

(71) Applicant: Samsung Electronics Co., Ltd., Suwon-si (KR)

(72) Inventors: Wonjun KIM, Suwon-si (KR); Suhwook KIM, Suwon-si (KR); Jungsuk BAIK, Suwon-si (KR)

(21) Appl. No.: 19/082,903

(22) Filed: Mar. 18, 2025

(30) Foreign Application Priority Data
Apr. 25, 2024 (KR) 10-2024-0055630
Oct. 23, 2024 (KR) 10-2024-0145586

(51) Int. Cl. H04B 7/06; H04W 24/02

(52) U.S. Cl. CPC H04B 7/0626; H04W 24/02

(57) ABSTRACT

User equipment in a wireless communication system is provided. The user equipment includes a transceiver, and a controller coupled to the transceiver, wherein the controller is configured to receive a first channel state information (CSI)-reference signal (RS) from a base station at a first time, perform artificial intelligence (AI)-based CSI compression, based on the first CSI-RS, transmit first feedback according to the AI-based CSI compression to the base station, receive a second CSI-RS from the base station at a second time, perform AI-based CSI variation compression, based on a variation value between the second CSI-RS and the first CSI-RS, and transmit second feedback according to the AI-based CSI variation compression to the base station.

### CROSS-REFERENCE TO RELATED APPLICATION(S)

This application is based on and claims priority under 35 U.S.C. § 119 (a) of a Korean patent application number 10-2024-0055630, filed on Apr. 25, 2024, in the Korean Intellectual Property Office, and of a Korean patent application number 10-2024-0145586, filed on Oct. 23, 2024, in the Korean Intellectual Property Office, the disclosure of each of which is incorporated by reference herein in its entirety.

### BACKGROUND

### 1. Field

The disclosure relates to a wireless communication system. More particularly, the disclosure relates to a method and a device for detecting channel variation, based on an improved artificial intelligence (AI) model in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3THz bands). It is expected that, due to severer path loss and atmospheric absorption in the terahertz bands than those in millimeter wave (mm Wave) bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In a wireless communication system, channel state information (CSI) may be used to measure a state of a channel between a terminal and a base station. In this case, an artificial intelligence (AI) model may be used to reduce the overhead of a reference signal for CSI measurement and more effectively report CSI. Accordingly, a method for detecting a channel variation and reporting CSI through CSI compression, based on an AI model is being considered.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a wireless communication system.

Additional aspects will be set forth in part in the description which follows and, in part, will be apparent from the description, or may be learned by practice of the presented embodiments.

The technical subjects pursued in the disclosure may not be limited to the above-mentioned technical subjects, and other technical subjects which are not mentioned may be clearly understood from the following descriptions by those skilled in the art to which the disclosure pertains.

In accordance with an aspect of the disclosure, a method performed by a user equipment in a wireless communication system is provided. The method includes receiving a first channel state information (CSI)-reference signal (RS) from a base station at a first time, performing artificial intelligence (AI)-based CSI compression, based on the first CSI-RS, transmitting first feedback according to the AI-based CSI compression to the base station, receiving a second CSI-RS from the base station at a second time, performing AI-based CSI variation compression, based on a variation value between the second CSI-RS and the first CSI-RS, and transmitting second feedback according to the AI-based CSI variation compression to the base station.

In accordance with another aspect of the disclosure, a method performed by a base station in a wireless communication system is provided. The method includes transmitting a first channel state information (CSI)-reference signal (RS) to a user equipment at a first time, receiving, from the user equipment, first feedback obtained by performing artificial intelligence (AI)-based CSI compression based on the first CSI-RS, transmitting a second CSI-RS to the user equipment at a second time, receiving, from the user equipment, second feedback obtained by performing AI-based CSI variation compression, based on a variation value between the second CSI-RS and the first CSI-RS, and performing CSI reconstruction, based on the first feedback and the second feedback.

In accordance with another aspect of the disclosure, a user equipment in a wireless communication system is provided. The user equipment includes a transceiver, and a controller coupled to the transceiver, wherein the controller is configured to receive a first channel state information (CSI)-reference signal (RS) from a base station at a first time, perform artificial intelligence (AI)-based CSI compression, based on the first CSI-RS, transmit first feedback according to the AI-based CSI compression to the base station, receive a second CSI-RS from the base station at a second time, perform AI-based CSI variation compression, based on a variation value between the second CSI-RS and the first CSI-RS, and transmit second feedback according to the AI-based CSI variation compression to the base station.

In accordance with another aspect of the disclosure, a base station in a wireless communication system is provided. The base station includes a transceiver, and a controller coupled to the transceiver, wherein the controller is configured to transmit a first channel state information (CSI)-reference signal (RS) to a user equipment at a first time, receive, from the user equipment, first feedback obtained by performing artificial intelligence (AI)-based CSI compression based on the first CSI-RS, transmit a second CSI-RS to the user equipment at a second time, receive, from the user equipment, second feedback obtained by performing AI-based CSI variation compression, based on a variation value between the second CSI-RS and the first CSI-RS, and perform CSI reconstruction, based on the first feedback and the second feedback.

Various embodiments of the disclosure provide a device and a method capable of effectively providing services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless communication environment according to an embodiment of the disclosure;

FIG. 2 illustrates an example of a structure of a base station in a wireless communication system according to an embodiment of the disclosure;

FIG. 3 illustrates an example of a configuration of a terminal in a wireless communication system according to an embodiment of the disclosure;

FIG. 4 illustrates an example of a process of reporting channel state information (CSI) by using an artificial intelligence (AI) model in a wireless communication system according to an embodiment of the disclosure;

FIG. 5 illustrates an example of a process of performing codebook-based CSI reporting in a wireless communication system according to an embodiment of the disclosure;

FIG. 6 illustrates an example of a process of performing CSI compression and reporting using an AI model in a wireless communication system according to an embodiment of the disclosure;

FIG. 7 illustrates an example of a process of compressing a CSI variation by using an AI model according to an embodiment of the disclosure;

FIG. 8 illustrates a flow of a signal for compressing and reporting a CSI variation, based on an AI model according to an embodiment of the disclosure;

FIG. 9 illustrates an example for compressing and reconstructing a CSI variation, based on an AI model according to an embodiment of the disclosure;

FIG. 10 illustrates a flow of a signal for compressing and reporting a CSI variation by considering a terminal capability and using an AI model according to an embodiment of the disclosure;

FIG. 11 illustrates a flow of a signal for compressing and reporting a CSI variation, based on an AI model trained by a base station according to an embodiment of the disclosure;

FIG. 12 illustrates a flow of a signal for compressing and reporting a CSI variation, based on an AI model trained by a terminal according to an embodiment of the disclosure;

FIG. 13 illustrates a flow of a signal for compressing and reporting a CSI variation, based on an AI model trained by a terminal according to a preference of a base station according to an embodiment of the disclosure;

FIG. 14 illustrates a flow of a signal for reconfiguring a parameter for CSI compression according to an embodiment of the disclosure; and

FIG. 15 illustrates an effect according to CSI variation compression and reporting based on an AI model in comparison with codebook-based CSI reporting according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description, terms referring to device elements (e.g., control unit, processor, artificial intelligence (AI) model, encoder, decoder, autoencoder (AE), and neural network (NN) model), terms referring to data (e.g., signal, feedback, report, reporting, information, parameter, value, bit, and codeword), and the like are illustratively used for the sake of descriptive convenience. Therefore, the disclosure is not limited by the terms as used below, and other terms having equivalent technical meanings may be used.

Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

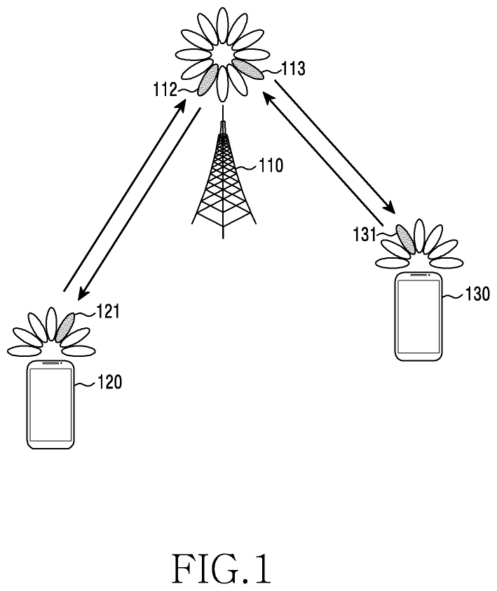

FIG. 1 illustrates a wireless communication system according to an embodiment of the disclosure. FIG. 1 illustrates a base station 110, a user equipment (UE) 120, and a UE 130, as some of the nodes that use wireless channels in a wireless communication system. Although FIG. 1 illustrates only one base station, other base stations identical or similar to the base station 110 may be further included.

The base station 110 is a network infrastructure which provides wireless access to the UEs 120 and 130. The base station 110 has coverage which is defined as a certain geographical area, based on a distance over which a signal can be transmitted. The base station 110 may be referred to as not only “base station” but also “access point (AP)”, “eNodeB (eNB)”, “gNodeB (gNB)”, “5th generation node (5G node)”, “6th generation node (gG node)”, “wireless point”, “transmission/reception point (TRP)”, or other terms having equivalent technical meanings.

Each of the UE 120 and the UE 130 is a device used by a user and performs communication with the base station 110 through a wireless channel. In some cases, at least one of the UE 120 and the UE 130 may be operated without a user's involvement. That is, at least one of the UE 120 and the UE 130 may be a device performing machine-type communication (MTC), and may not be carried by a user. The UE 120 and the UE 130 may each be referred to as a “user equipment (UE)”, a “mobile station”, a “subscriber station”, a “customer-premises equipment (CPE)”, a “remote terminal”, a “wireless terminal”, an “electronic device”, a “user device”, or other terms having technical meanings equivalent thereto, as well as a terminal.

The base station 110, the UE 120, and the UE 130 may transmit and receive a wireless signal in a mm Wave band (e.g., 28 GHz, 30 GHz, 38 GHz, or over 60 GHz). In this regard, in order to improve a channel gain, the base station 110, the UE 120, and the UE 130 may perform beamforming. Here, beamforming may include transmission beamforming and reception beamforming. That is, the base station 110, the UE 120, and the UE 130 may apply directivity to transmission signals or reception signals. To this end, the base station 110 and the UEs 120 and 130 may select serving beams 112, 113, 121, and 131 through a beam search or beam management procedure. After the serving beams 112, 113, 121, and 131 are selected, subsequent communication may be performed through a resource having a quasi co-located (QCL) relationship with a resource through which the serving beams 112, 113, 121, and 131 have been transmitted.

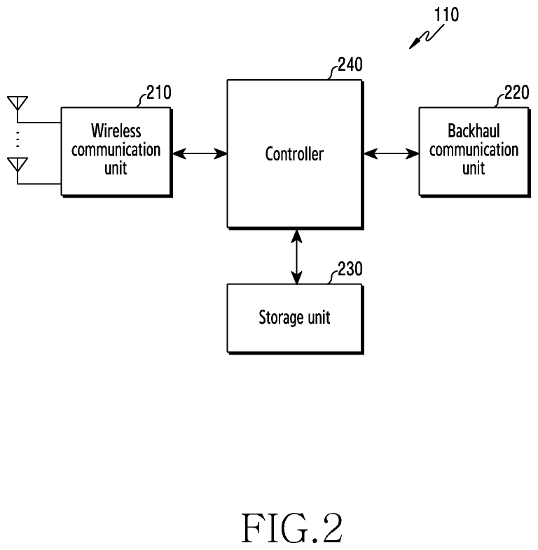

FIG. 2 illustrates an example of a structure of a base station in a wireless communication system according to an embodiment of the disclosure. According to various embodiments of the disclosure, a base station 110 may be referred to as “network” for the sake of convenience. The structure illustrated in FIG. 2 may be understood as a structure of the base station 110. As used herein, the term “ . . . unit”, “-er”, or the like refers to a unit configured to process at least one function or operation, and may be implemented as hardware, software, or a combination of hardware and software.

Referring to FIG. 2, the base station 110 may include a wireless communication unit 210, a backhaul communication unit 220, a storage unit 230, and a controller 240.

The wireless communication unit 210 performs functions for transmitting/receiving signals through a radio channel. For example, the wireless communication unit 210 performs functions of conversion between baseband signals and bitstrings according to the physical layer specifications of the system. For example, during data transmission, the wireless communication unit 210 generates complex symbols by encoding and modulating a transmission bitstream. In addition, during data reception, the wireless communication unit 210 demodulates and decodes a baseband signal to reconstruct a received bitstring. In addition, the wireless communication unit 210 up-converts a baseband signal to an RF band signal, transmits the same through an antenna, and down-converts an RF band signal received through the antenna to a baseband signal.

To this end, the wireless communication unit 210 may include a transmission filter, a reception filter, an amplifier, a mixer, an oscillator, a digital to analog converter (DAC), an analog to digital converter (ADC), and the like. In addition, the wireless communication unit 210 may include multiple transmission/reception paths. Furthermore, the wireless communication unit 210 may include at least one antenna array including multiple antenna elements. In terms of hardware, the wireless communication unit 210 may include a digital unit and an analog unit, and the analog unit may include multiple sub-units according to operation power, frequencies, etc.

The wireless communication unit 210 may transmit/receive signals. To this end, the wireless communication unit 210 may include at least one transceiver. For example, the wireless communication unit 210 may transmit a synchronization signal, a reference signal, system information, a message, control information, data, or the like. In addition, the wireless communication unit 210 may perform beamforming.

The wireless communication unit 210 transmits and receives signals as described above. Accordingly, all or a part of the wireless communication unit 210 may be referred to as “transmitter”, “receiver”, or “transceiver”. In addition, as used in the following description, the meaning of “transmission and reception performed through a radio channel” includes the meaning that the above-described processing is performed by the wireless communication unit 210.

The backhaul communication unit 220 provides an interface for performing communication with other nodes in the network. That is, the backhaul communication unit 220 converts, into a physical signal, a bitstream transmitted from the base station 110 to another node, for example, another access node, another base station, a higher node, a core network, etc., and converts a physical signal received from another node into a bitstream.

The storage unit 230 stores data, such as a default program, an application, and setting information, for the operation of the base station. The storage 230 may include memory. The storage unit 230 may include volatile memory, nonvolatile memory, or a combination of volatile memory and nonvolatile memory. In addition, the storage unit 230 provides the stored data at the request of the controller 240. According to an embodiment, the storage unit 230 may store training data for AI-based CSI reporting, and apply the stored training data to a neural network structure for AI-based CSI reporting.

The controller (or control unit) 240 controls the overall operation of the base station 110. For example, the controller 240 transmits/receives signals through the wireless communication unit % n or the backhaul communication unit 220. In addition, the controller 240 records data in the storage 230 and reads the data from the storage 230. Furthermore, the controller 240 may perform functions of protocol stacks required by communication specifications. To this end, the controller 240 may include at least one processor. According to various embodiments, the controller 240 may control the base station to perform operations according to various embodiments described below.

The structure of the base station 110 illustrated in FIG. 2 is a merely an example of the base station, and examples of the base station for performing various embodiment of the disclosure are not limited to the structure illustrated in FIG. 2. That is, some elements may be added, omitted, or changed according to various embodiments.

Referring to FIG. 2, the base station has been described as a single entity, but the disclosure is not limited thereto. In addition to the integrated deployment, the base station according to various embodiments of the disclosure may be implemented to construct an access network having a distributed deployment. According to an embodiment, the base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the base station may form beam coverage on a radio channel.

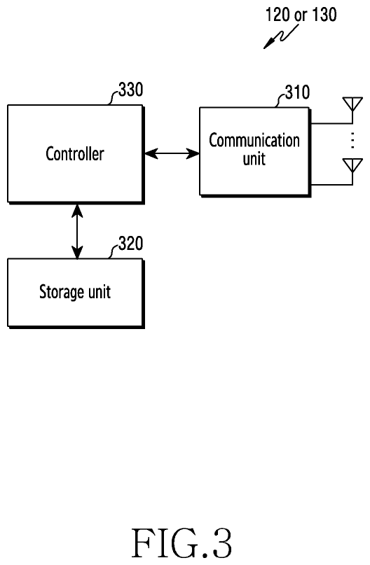

FIG. 3 illustrates an example of a configuration of a UE in a wireless communication system according to an embodiment of the disclosure. The configuration illustrated in FIG. 3 may be understood as a configuration of the UE 120 or 130. The term “ . . . unit” or the terms including the suffixes “-or”, “-er”, or the like used hereinafter may mean a unit of processing at least one function or operation, and this may be embodied by hardware, software, or a combination of hardware and software.

Referring to FIG. 3, the UE 120 or 130 may include a communication unit 310, a storage unit 320, and a controller 330.

The communication unit 310 performs functions for transmitting or receiving a signal through a wireless channel. For example, the communication unit 310 performs a function of conversion between a baseband signal and a bitstream according to a physical layer specification of a system. For example, at the time of data transmission, the communication unit 310 generates complex symbols by encoding and modulating a transmission bitstream. In addition, at the time of data reception, the communication unit 310 reconstructs a reception bitstream by demodulating and decoding a baseband signal. Furthermore, the communication unit 310 up-converts a baseband signal into an RF band signal and then transmits the converted RF band signal through an antenna, and down-converts an RF band signal received through an antenna into a baseband signal. For example, the communication unit 310 may include a transmission filter, a reception filter, an amplifier, a mixer, an oscillator, a DAC, an ADC, and the like.

In addition, the communication unit 310 may include a plurality of transmission or reception paths. Moreover, the communication unit 310 may include an antenna unit. The communication unit 310 may include at least one antenna array configured by a plurality of antenna elements. In view of hardware, the communication unit 310 may be configured by a digital circuit and an analog circuit (e.g., radio frequency integrated circuit (RFIC)). The digital circuit and the analog circuit may be implemented as a single package. In addition, the communication unit 310 may include a plurality of RF chains. The communication unit 310 may perform beamforming. The communication unit (310 may apply a beamforming weight to a signal to be transmitted or received, to give the signal directivity based on a configuration of the controller 330. According to an embodiment, the communication unit 310 may include a radio frequency (RF) block (or RF unit). The RF block may include a first RF circuit (circuitry) related to an antenna and a second RF circuit (circuitry) related to baseband processing. The first RF circuit may be called RF-A (antenna). The second RF circuit may be called RF-B (baseband).

In addition, the communication unit 310 may transmit or receive a signal. To this end, the communication unit 310 may include at least one transceiver. The communication unit 310 may receive a downlink signal. A downlink signal may include a synchronization signal (SS), a reference signal (RS) (e.g., cell-specific reference signal (CRS) or demodulation (DM)-RS), system information (e.g., MIB, SIB, remaining system information (RMSI), or other system information (OSI)), a configuration message, control information, or downlink data. In addition, the communication unit 310 may transmit an uplink signal. An uplink signal may include a random access-related signal (e.g., random access preamble (RAP) (or message 1 (Msg 1) or message 3 (Msg 3)), a reference signal (e.g., sounding reference signal (SRS)) or DM-RS), or a power headroom report (PHR).

In addition, the communication unit 310 may include different communication modules to process signals in different frequency bands. Furthermore, the communication unit 310 may include a plurality of communication modules for supporting a plurality of different wireless access technologies. For example, the different wireless access technologies may include Bluetooth low energy (BLE), wireless fidelity (Wi-Fi), Wi-Fi gigabyte (WiGig), a cellular network (e.g., long-term evolution (LTE) or new radio (NR)), and the like. In addition, the different frequency bands may include a super high frequency (SHF) (e.g., 2.5 GHz or 5 GHZ) band and a millimeter (mm) wave (e.g., 38 GHz or 60 GHz) band. In addition, the communication unit 310 may use the same type of wireless access technology in different frequency bands (e.g., an unlicensed band for licensed assisted access (LAA) and citizens broadband radio service (CBRS) (e.g., 3.5 GHZ)).

The communication unit 310 transmits and receives a signal as described above. Accordingly, the entirety or a part of the communication unit 310 may be called “a transmitter”, “a receiver”, or “a transceiver”. Furthermore, in the following description, transmission and reception performed through a wireless channel is used as a meaning of including the above processing being performed by the communication unit 310.

The storage unit 320 stores data such as a basic program, an application program, and configuration information for an operation of the UE 120. The storage unit 320 may be configured by volatile memory, nonvolatile memory, or a combination of volatile memory and nonvolatile memory. The storage unit 320 provides stored data according to a request of the controller 330. According to an embodiment, the storage unit 320 may store training data for AI-based CSI reporting according to a CSI configuration configured by a base station.

The controller 330 controls overall operations of the UE 120 or 130. For example, the controller 330 transmits and receives a signal through the communication unit 310. In addition, the controller 330 records and reads data in and from the storage unit 320. Moreover, the controller 330 may perform functions of a protocol stack required in a communication specification. To this end, the controller 330 may include at least one processor. The controller 330 may include at least one processor or microprocessor, or may be a part of a processor. In addition, the controller 330 and a part of the communication unit 310 may be called a cellular processor (CP). The controller 330 may include various modules for performing communication. According to various embodiments, the controller 330 may control the UE to perform operations according to various embodiments.

According to various embodiments, an AI model trained based on a neural network may be operated through the controller 330 and the storage unit 320. In this case, the controller 330 may be configured by one or multiple processors. The one or multiple processors may include a function of a general-purpose processor such as a CPU, an application processor (AP), or a digital signal processor (DSP), a graphics-dedicated processor such as a graphics processing unit (GPU) or a vision processing unit (VPU), or an artificial intelligence-dedicated processor such as an NPU. The one or multiple processors may perform control to process input data according to an artificial intelligence model or a pre-defined operation rule stored in the storage unit 320. Alternatively, if the one or multiple processors are artificial intelligence-dedicated processors, the artificial intelligence-dedicated processors may be designed to be a hardware structure specified for processing of a particular artificial intelligence model. The artificial intelligence-dedicated processors may not be included in the controller 330 and be included as a separate configuration.

According to an embodiment, the pre-defined operation rule or artificial intelligence model is made through training. Here, being made through training means that a pre-defined operation rule or artificial intelligence model configured to perform a desired property (or purpose) is made by training a basic artificial intelligence model by using multiple pieces of training data according to a training algorithm. This training may be performed in a device itself in which artificial intelligence according to the disclosure is performed, or may be performed through a separate server and/or system. As an example of the training algorithm, there are supervised learning, unsupervised learning, semi-supervised learning, or reinforcement learning, but the disclosure is not limited to the above example. The controller 330 may learn an event that occurs, a determination that is made, or collected or input information, through the training algorithm. The controller 330 may store such a training result in the storage unit 320 (e.g., memory).

An artificial intelligence model (AI model) may be configured by multiple neural network layers. Each of the multiple neural network layers has multiple weight values, and may perform a neural network computation through computation between the multiple weights and a computation result of a previous layer. The multiple weight values that the multiple neural network layers have may be optimized by a training result of the artificial intelligence model. For example, the multiple weight values may be updated to reduce or minimize a loss value or cost value obtained by the artificial intelligence model during a training process. The artificial neural network may include a deep neural network (DNN) and, for example, include a convolutional neural network (CNN), a deep neural network (DNN), a recurrent neural network (RNN), a restricted Boltzmann machine (RBM), a deep belief network (DBN), a bidirectional recurrent deep neural network (BRDNN), a transformer), long short term memory (LSTM), or a deep Q-Network, but is not limited to the example.

In an embodiment, the controller 330 may execute an algorithm for performing an operation related to channel state information (CSI) reporting or feedback based on artificial intelligence (AI). In an embodiment, an AI model trained to perform an operation related to AI-based CSI feedback may be configured in the controller 330 hardware-wise, software-wise, or through a combination of hardware and software. In other words, the controller 330 may include an AI-based CSI feedback controller. The AI-based CSI feedback controller may perform AI-based channel prediction, identification of prediction performance for each channel, determination of whether to report a result of the identification, or determination of whether to use AI-based CSI feedback. In addition, according to various embodiments, the controller 330 may include an update unit. The update unit may obtain pieces of data updated by a training procedure between the UE and the base station (e.g., data related to CSI feedback between the UE and the base station), and reconfigure the values of parameters (e.g., a neural network structure, node layer-specific information, and weight information between nodes) configuring a neural network, based on the obtained pieces of data. The AI-based CSI feedback controller and the update unit may be, as an instruction set or code stored in the storage unit 320, an instruction/code that at least temporarily resides in the controller 330 or a storage space storing the instruction/code, or a part of a circuit (circuitry) configuring the controller 330. According to various embodiments, the controller 330 may control the UE 120 or 130 to perform operations according to various embodiments.

The configuration of the UE 120 or 130 illustrated in FIG. 3 merely corresponds to an example of a UE, and an example of a UE performing various embodiments of the disclosure is not limited to the configuration illustrated in FIG. 3. That is, according to various embodiments, a part of the configuration may be added, removed, or changed.

Hereinafter, for convenience of explanation, in the disclosure, a description based on an AI model included in the UE 120 or 130 is provided. That is, an AI model including a particular neural network structure and trained by a particular algorithm may be included in the UE 120 or 130. However, the disclosure is not limited thereto and is also applicable to an AI model included in the base station 110.

A technology related to AI-based CSI feedback may include training and configuring based on a particular algorithm to apply CSI feedback to a particular AI model, collecting training data required in a process of training the particular AI model, and verifying the performance of the trained particular AI model. In particular, the disclosure may further include an operation for detecting, by a UE, a channel variation, based on an AI model and compressing and reporting same so as to perform CSI feedback through an optimal AI model.

In explaining an AI model-based CSI reporting method of the disclosure, for convenience, an AI model is described using an autoencoder (AE) as an example. However, the disclosure is not limited thereto, and is also applicable to all AI models capable of CSI compression in performing CSI reporting. Here, the autoencoder has a structure having the same input and output and may indicate an AI model including a bottleneck structure. The autoencoder may compress measured CSI or a variation of CSI into a low-dimensional vector form. In other words, the UE may generate compressed CSI through an encoder of the autoencoder from measured full CSI or CSI variation and transmit the compressed CSI to the base station. Accordingly, the base station may receive explicit CSI feedback rather than implicit CSI feedback. The autoencoder may be advantageous in relation to a method of reporting through a CSI compression method. For example, even when the performance of the AI model is inferred, since the autoencoder is aware of a ground-truth of original data, the autoencoder may accurately evaluate the AI model. That is, the autoencoder is aware of an input value of the autoencoder, and thus the performance of the autoencoder may be measured by comparing the output value of the autoencoder with the input value. When the autoencoder is aware of an actual value of original data, the autoencoder may accurately predict which value is to be output according to a value input to the autoencoder. In addition, since the autoencoder has high data dependency, the autoencoder may also be used for anomaly detection for detecting unlearned data. According to various embodiments of the disclosure, the UE and the base station may include a separate autoencoder for CSI variation together with an autoencoder for measured CSI (e.g., an encoder of the UE and a decoder of the base station). However, the disclosure is not limited thereto, and the UE and the base station may perform compression (or encoding) or reconstruction (or decoding) for CSI and CSI variation through a single autoencoder. According to various embodiments, as described above, an artificial intelligence model may include an autodecoder or an autoencoder for performing CSI compression. In addition, the UE 120 or 130 or the base station 110 may include an encoder/decoder for compressing channel variation separately from (or including) an encoder/decoder for CSI compression.

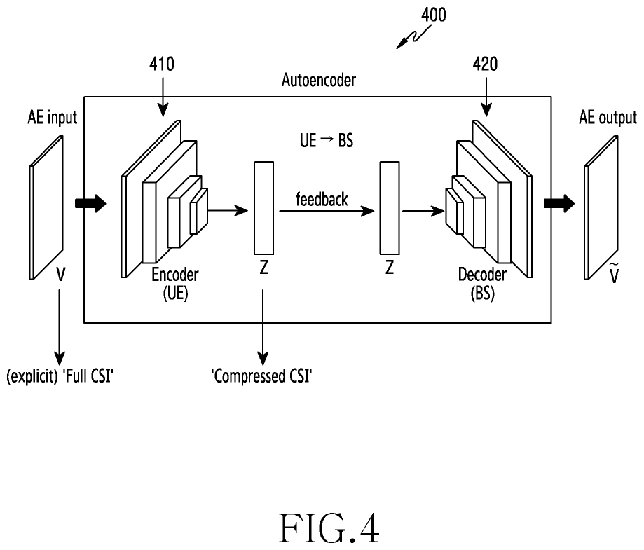

FIG. 4 illustrates an example of a process of reporting channel state information (CSI) by using an artificial intelligence (AI) model in a wireless communication system according to an embodiment of the disclosure. In FIG. 4, an autoencoder is described as an example of an AI model for reporting CSI (or performing CSI feedback), but the disclosure is not limited thereto. Here, the autoencoder for reporting CSI is assumed as an AI model trained to report CSI, based on a particular training algorithm.

Referring to FIG. 4, an autoencoder 400 may be an AI model trained for CSI reporting or feedback between a UE and a base station. The UE may generate CSI by pre-processing information on a channel estimated based on a result of measuring a signal received from the base station. For example, the pre-processing may include eigen value decomposition (EVD) or singular value decomposition (SVD). Here, the generated CSI may indicate full CSI. The full CSI may be input to an encoder 410 of the UE that is an input of the autoencoder 400, and accordingly, compressed CSI may be generated. The UE may transmit the compressed CSI to the base station, and the base station may restore (or reconstruct) the compressed CSI through the decoder 420. A decoder 420 of the base station may be an output of the autoencoder 400. According to the above description, the autoencoder 400 may be trained with CSI compression which is usable for CSI feedback between the UE and the base station. The autoencoder 400 may perform explicit CSI feedback rather than implicit CSI feedback through feedback based on a trained CSI compression method. The CSI compression method may require stable performance and high accuracy of the autoencoder 400. Therefore, according to an embodiment, a procedure of managing the autoencoder 400 by the UE by reporting, to the base station, a result of evaluation through continuously and periodically monitoring the performance of the autoencoder 400 is required. Based on the above description, according to various embodiments of the disclosure, an operation for more efficiently performing CSI reporting based on an AI model is described. Hereinafter, CSI mentioned therefor may indicate at least one of full CSI or compressed CSI.

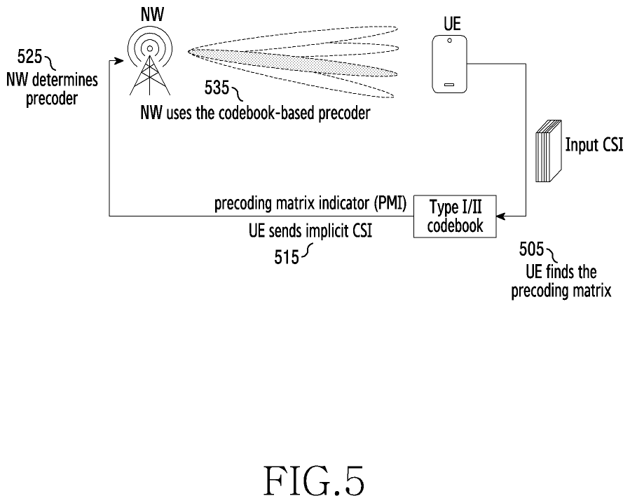

FIG. 5 illustrates an example of a process of performing codebook-based CSI reporting in a wireless communication system according to an embodiment of the disclosure. More specifically, FIG. 5 illustrates an example of a process for performing legacy CSI reporting.

Wireless communication technology has evolved in various ways to provide faster data rates, enhanced application range, and more stable connections. In particular, multiple input multiple output (MIMO) technology, which increases the number of antennas for transmission and reception to achieve performance gains especially in relation to the physical layer, has been introduced. Accordingly, 5G new radio (NR) systems support up to 32 antenna ports, and future 6G systems aim to commercialize eXtreme massive MIMO (X-MIMO) technology in new frequency bands (e.g., FR3 (10 GHZ-13 GHZ)) and enable transmission with up to 256 ports.

As described above, an increased number of CSI-RS ports may be required for channel estimation. In an NR system, since a UE feeds back, to a base station, CSI for the channel estimated from each CSI-RS, an increase in the number of CSI-RS ports may lead to higher CSI feedback overhead. The disclosure proposes a solution to solve the overhead increase for a precoding matrix indicator (PMI).

Referring to FIG. 5, a process for codebook-based CSI feedback in a wireless communication system is illustrated. In operation 505, a UE may estimate a proper channel, based on a CSI-RS received from a base station. In operation 515, a UE may configure a PMI, based on a codebook (e.g., Type I/Type II codebook) and the estimated channel, and report the PMI to the base station. In operation 525, the base station may determine a precoder according to the PMI (e.g., CSI report) received from the UE, and in operation 535, determine a beam for transmission and reception with the UE by using the codebook-based precoder. In this case, as described above, since the overhead according to PMI increases in proportional to the number of CSI-RS ports, overhead for supporting more ports may considerably increase.

The disclosure proposes, as described above, various methods for solving the problems that may occur according to a conventional CSI reporting method, and hereinafter, the methods will be described in detail.

Recently in third generation partnership project (3GPP), artificial intelligence-based CSI feedback has been actively studied as a representative application of AI radio access networks (RAN). Additionally, many cellular vendors are independently developing AI-based CSI feedback solutions. As described above, AI-based CSI feedback may employ an autoencoder configured by an encoder and a decoder. More specifically, the encoder at a UE may compress CSI and then, the decoder at a base station may generate the reconstructed CSI. Such an AI-based CSI feedback method may significantly reduce CSI feedback overhead. However, further improvements are needed to support a next-generation eXtreme multiple-input multiple-output system, where the number of antenna ports increases significantly (e.g., 64/128 CSI-RS ports).

To this end, the disclosure provides a new type of AI-based CSI feedback (feedback using the temporal correlation between channels in the spatial frequency domain), based on a hybrid neural network configured by dual autoencoders (e.g., transformer-based autoencoders). More specifically, various embodiments include various methods in which a first autoencoder that provides feedback for a spatial frequency domain (SF domain) channel and then, in a next feedback period, a second autoencoder (e.g., which may be implemented separately from or identical to the first autoencoder) compresses and reports a channel variation between two consecutive CSI periods. Accordingly, a base station may reconstruct CSI at the current time by decoding only information according to the channel variation in addition to previously known CSI of the previous period. The number of feedback bits required for compressing only a CSI variation between adjacent CSI periods rather than the entire channel is smaller compared to the entire channel, and thus the feedback overhead may be significantly reduced. In other words, according to various embodiments, AI-based channel variation feedback (AI-CVF) may maintain high feedback quality while achieving a 12% improvement in quality and a 52% reduction in overhead compared to a conventional codebook-based feedback method.

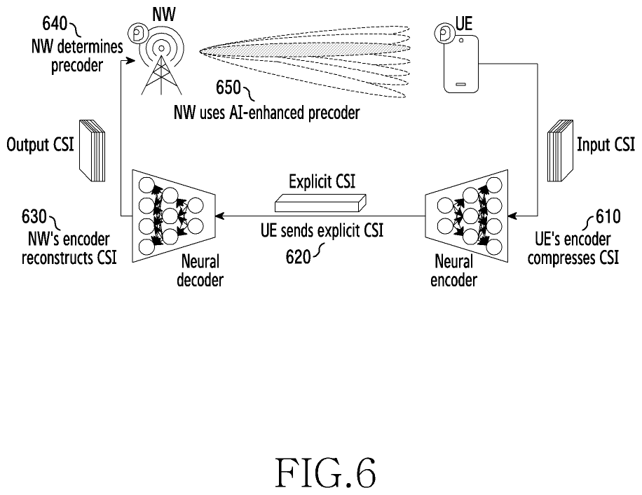

FIG. 6 illustrates an example of a process of performing CSI compression and reporting using an AI model in a wireless communication system according to an embodiment of the disclosure. More specifically, referring to FIG. 6, an AI-based CSI compress technique for reducing the overhead of CSI feedback is illustrated. A UE and a base station may use an autoencoder structure configured by an encoder and a decoder for CSI compression.

In operation 610, the UE may compress input CSI (e.g., channel eigenvector) obtained based on a CSI-RS, by using the encoder. In operation 620, the UE may transmit a vector (e.g., explicit CSI) compressed by the encoder to the base station. In operation 630, the base station may use the compressed vector as an input of the decoder and reconstruct the CSI by using the decoder. In operation 640, the base station may determine a precoder according to the reconstructed CSI from the UE, and in operation 650, determine a beam for transmission and reception by using the AI-based precoder.

Referring to FIG. 6, hereinafter, for a CSI compression process described above, CSI compression will be described in more detail. According to an embodiment, an OFDM-based MIMO system including Nₜ transmission antennas and Nᵣ reception antennas may be considered. In this case, when the n-th subcarrier symbol xₙ is transmitted, a reception signal may be yₙ=HₙPₙxₙ=zₙ, Hₙ∈C^{Nr×Nt}˜may be a spatial channel matrix, Pₙ may be a precoding vector, and zₙ may be a Gaussian noise vector.

In order to achieve maximum precoding gain, the direction of Pₙ needs to match that of Hₙ. To this end, vₙ that is the eigenvector of Hₙ may be used, and thus the UE needs to report vₙ to the base station. In conventional codebook-based CSI feedback, vₙ may be quantized using discrete Fourier transform. On the contrary, in a case of an autoencoder for CSI compression in the spatial frequency domain, the encoder at the UE may compress the eigenvector V=[v⁽¹⁾, . . . , v^{(Ns)}]′ for Nₛsubbands into the latent vector z, and the decoder at the base station may reconstruct the original eigenvector\hat{V} from z.

According to various embodiments, other than the correlation of the spatial frequency domain described above, channels may have a temporal correlation in a channel coherence time due to Doppler frequency, etc. As a method for solving this problem, a technique for jointly compressing channels in the temporal-spatial frequency domain is proposed. However, the method provides little gain compared to spatial frequency CSI compression, and both a UE and a base station need to process the entire channel in every CSI period, which may lead to issues due to limited capacity. Hereinafter, to address the limited capacity issue while using the features of the aforementioned CSI compression technique, methods for compressing a channel variation to report CSI according to various embodiments of the disclosure are specifically described.

To repeat the conventional problems, in a case of increased frequency bands, such as recent 6G frequencies (e.g., upper-mid bands (10 GHz and 13 GHZ)), integration of a greater number of antennas within the same area has become possible, which may lead to a significant increase in CSI feedback overhead. If CSI feedback overhead is simply restricted, MIMO performance may deteriorate, potentially resulting in reduced throughput for a cell or UE. That is, if the aforementioned CSI compression technique is only used, efficient CSI compression performance may be achieved due to AI. However, the technique does not reflect the temporal variation property of the channel in that measured CSI is compressed in each CSI-RS period, and may cause issues related to limited capacity.

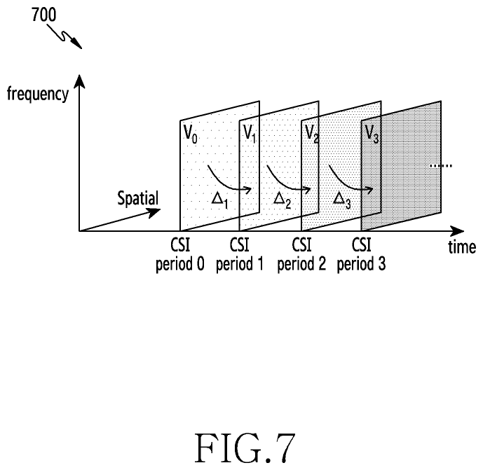

FIG. 7 illustrates an example of a process of compressing a CSI variation by using an AI model according to an embodiment of the disclosure. More specifically, referring to FIG. 7, a CSI compression method reflecting a property according to a temporal variation of a channel is described.

According to various embodiments, AI may efficiently compress data and accurately restore the compressed data to be close to the original, through a data-driven property (feature). Referring to FIG. 7, a CSI feedback method 700 of compressing a channel variation by using AI is illustrated.

According to an embodiment, a channel has a property of changing based on a temporal (time) correlation and thus, when the property is used for AI compression, the compression performance may be increased. Referring to FIG. 7, a UE may obtain channel information (e.g., V₀ to V₃) according to the frequency axis and the spatial axis in every CSI period (e.g., CSI period 0 to CSI period 3). Based on a conventional AI autoencoder, the UE may compress each of the obtained channel information and report same to a base station in a corresponding period, and thus, the base station is required to decode pieces of explicit CSI compression information in respective periods. However, in the disclosure, the UE may detect, compress, and report a channel variation (e.g., Δ₁ to Δ₃) based on channel information of the previous period rather than channel information itself. Therefore, there are technical effects in terms of capacity and overhead compared to conventional CSI compression of compressing and feeding back CSI itself. In addition, according to various embodiments, an AI model used to feed back a channel variation may include a two-sided model to be used by each of the UE and the base station for an encoder or decoder. Therefore, the subject (e.g., the UE or base station) which operates training of such an AI model may also be an important feature.

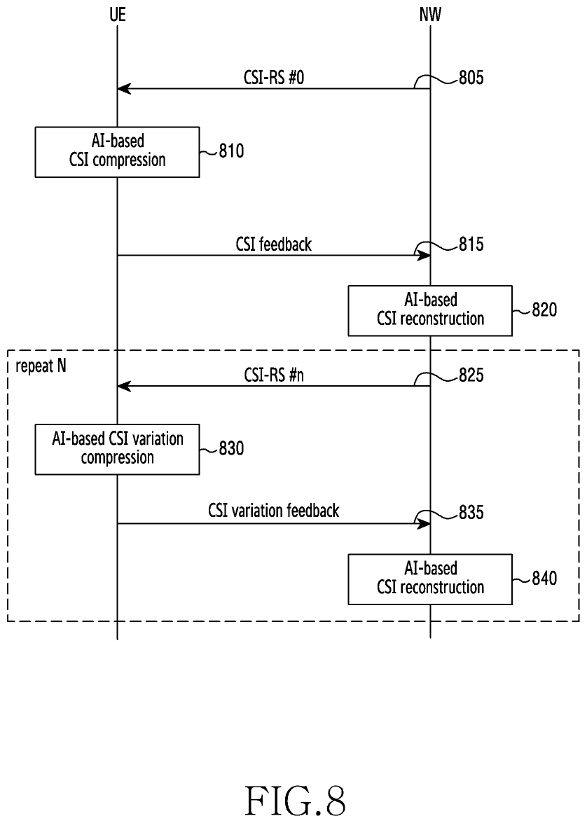

FIG. 8 illustrates a flow of a signal for compressing and reporting a CSI variation, based on an AI model according to an embodiment of the disclosure. More specifically, FIG. 8 illustrates a CSI feedback method for compressing a channel variation together with compression of CSI itself according to various embodiments.

In operation 805, a base station may transmit a CSI-RS to a UE. More specifically, the base station may transmit CSI-RS #0 corresponding to a particular time to the UE. According to an embodiment, CSI-RS #0 transmitted by the base station at the corresponding time may be, hereinafter, used as a reference point for channel variation feedback (CVF) at a future time. The CSI-RS transmitted by the base station is a reference signal for channel state reporting and may include a reference signal defined in a standard specification.

In operation 810, the UE may perform AI-based CSI compression. More specifically, the UE may determine channel state information, based on CSI-RS #0 received from the base station and compress an eigenvector relating to the channel state information by using an AI encoder. The UE may obtain the latent vector z as compressed CSI. Specific content for CSI compression may be based on the above description.

In operation 815, the UE may transmit CSI feedback to the base station. More specifically, the UE may report the compressed CSI information (e.g., the latent vector z) to the base station.

In operation 820, the base station may reconstruct AI-based CSI. More specifically, the base station may restore the compressed CSI information received from the UE to the CSI having been determined by the UE, by using an AI decoder.

In operation 825, the base station may transmit a CSI-RS to the UE at a time point different from before. More specifically, the base station may transmit, to the UE, CSI-RS #n corresponding to the time point different from that of operation 805. The CSI-RS transmitted by the base station is a reference signal for channel state reporting and may include a reference signal defined in a standard specification.

In operation 830, the UE may perform AI-based CSI variation compression. More specifically, the UE may determine channel state information, based on CSI-RS #n received from the base station and compare same with a channel state based on CSI-RS #0 obtained at the previous time point, to determine a channel variation value. The UE may compress an eigenvector relating to the obtained channel variation value by using the AI encoder. The UE may obtain the latent vector z as compressed channel variation information.

In operation 835, the UE may transmit channel variation feedback to the base station. More specifically, the UE may report the compressed channel variation information (e.g., the latent vector z) to the base station.

In operation 840, the base station may reconstruct AI-based CSI. More specifically, the base station may process, as an input of the AI decoder, the compressed channel variation information received from the UE in operation 835 together with the CSI information having been previously obtained at the previous time point (e.g., the information includes both CSI information having not been decoded for compression yet and CSI information having been decoded and restored), so as to restore the CSI at the corresponding time point.

According to various embodiments, operation 825 to operation 840 may be repeated one or more times, and may be performed only for some of CSI-RSs periodically transmitted by the base station. For example, between operation 820 and operation 825, although not illustrated, at least one (AI-based or legacy-based) CSI-RS feedback/channel variation feedback process between the UE and the base station may be included or omitted. Hereinafter, with respect to an operation of FIG. 8, more specific content including an encoder/decoder structure is described.

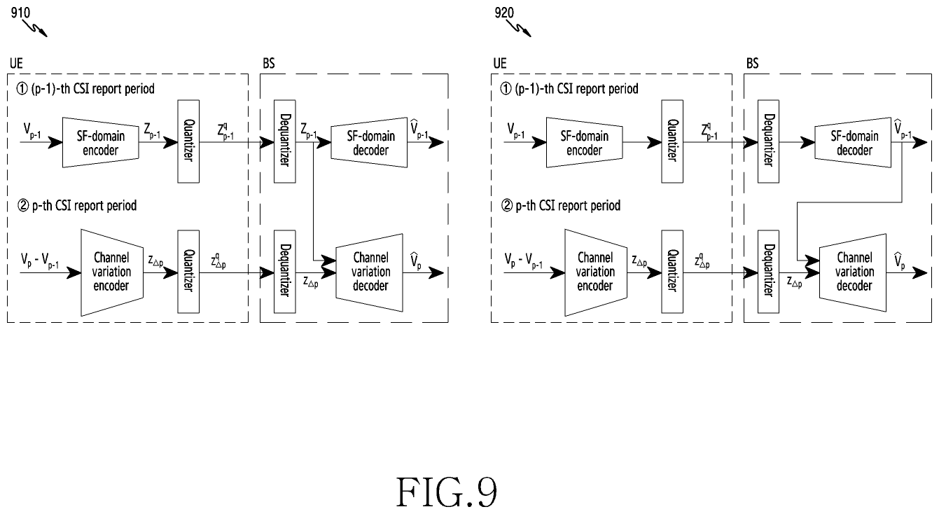

FIG. 9 illustrates an example for compressing and reconstructing a CSI variation, based on an AI model according to an embodiment of the disclosure. More specifically, referring to FIG. 9, a structure of an AI autoencoder for performing an operation between the UE and the base station described with reference to FIG. 8 and an example of signal processing using the structure are illustrated.

Referring to FIG. 9, the AI autoencoder (hereinafter, this may be called AI-based CVF) may be configured by two stages. For example, AI CVF may include SF domain compression for compression and restoration of reference CSI (e.g., anchor CSI) and channel variation compression for compression and restoration of variation information between the reference CSI and current CSI. Such dual-stage AI CVF may use an SF domain autoencoder configured by an SF domain encoder and an SF domain decoder and a channel variation autoencoder configured by a channel variation encoder and a channel variation decoder. However, this merely corresponds to an example, and the SF domain autoencoder and the channel variation autoencoder may be configured as one hardware or logical entity to be implemented as an autoencoder capable of performing both compression (or restoration) of the SF domain and compression (or restoration) for channel variation information.

Referring to CVF of a first example 910, p−1-th CSI and the compressed p-th CSI may be used for p-th CSI feedback. For example, first, a UE may use an SF domain encoder to compress \hat{V}ₚ₋₁, which is p−1-th CSI used as reference CSI (e.g., anchor CSI), into Zₚ₋₁. The information compressed by the UE may be quantized and then be transmitted to a base station, and the base station may dequantize the quantized information and store the value thereof or restore same into \hat{V}ₚ−ₚ₋₁ by using an SF domain decoder.

According to an embodiment, in the p CSI feedback, the UE may compress a variation value between Vₚ and Vₚ₋₁ rather than compressing Vₚ. However, this merely corresponds to an example, and the variation may include various information or definitions acquirable between the two pieces of information, and Vₚ−Vₚ₋₁ may be an example thereamong. The UE may compress Vₚ−Vₚ₋₁ into Zap and transmit same to the base station. The information compressed by the UE may be quantized and then be transmitted to the base station, and the base station may dequantize the quantized information and use Z_{Δp} that is a compressed vector value for a variation value and Zₚ₋₁ that is a CSI value stored at the previous time point as an input of a channel variation decoder, so as to restore \hat{V}ₚ.

Referring to CVF of a second example 920, a UE and a base station may perform signal processing and information transmission and reception as in the first example 910. However, unlike the first example 910, the base station may use, as an input of a channel variation decoder, Vₚ₋₁ that is a CSI value previously restored in a p−1-th reporting period rather than Z_{ΔP-1} that is a compressed vector for a variation value. However, each example merely corresponds to an example, and the base station may be configured to use both the above two cases according to an implementation method. In addition, for convenience of explanation, respective reporting periods have been described as continuous time points such as a p−1-th period and a p-th period. However, this merely corresponds to an example, a reporting period for reporting compressed channel variation information is not necessarily required to be a time point continuous to the previous time point. For example, a reporting period for reporting compressed channel variation information and a CSI reporting period may be different from each other.

In addition to the aforementioned embodiment, as a more specific CVF operation method, a more specific procedure between a UE and a base station, such as CVF operation for training an AI model, CVF operation according to network-based model transfer, and CVF operation according to UE-based model transfer, is described. However, according to various embodiments, the detailed operations expressed in the drawings of the disclosure are not necessarily essential elements. It is naturally possible for an embodiment to include at least one of all, some, or a combination of some of operations.

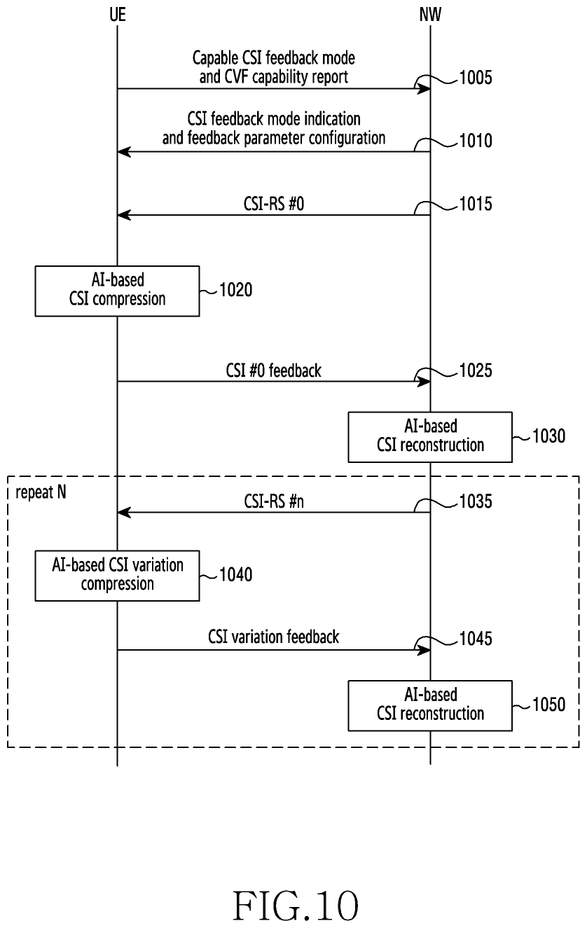

FIG. 10 illustrates a flow of a signal for compressing and reporting a CSI variation by considering a UE capability and using an AI model according to an embodiment of the disclosure. More specifically, referring to FIG. 10, a CVF procedure based on a model subjected to separate training is illustrated. Here, separate training may indicate a UE and a base station separately training their respective encoder or decoder.

In operation 1005, a UE may transmit UE capability information to a base station. The capability information transmitted by the UE may include at least one of information on a CSI feedback mode supported by the UE or information on CVF capability reporting. More specifically, the UE may report, to the base station, a CSI feedback mode operable by the UE and CVF capability information on a CVF model trained by the UE.

According to various embodiments, the CSI feedback mode supported by the UE may include AI-based CSI feedback modes determined according to the processing capability/cost of the UE. Below, Table 1 shows an example of the CSI feedback modes supported by the UE.

TABLE 1

| Index | CSI feedback mode |
|---|---|
| 0 | AI-disabled feedback (i.e., codebook-based feedback) |
| 1 | AI-enabled compression-based feedback |
| 2 | AI-enabled variation compression-based feedback |

According to an embodiment, if the UE does not support an AI model or AI-based CSI feedback (e.g., if the UE is a non-AI UE), the UE may report conventional codebook-based feedback as a possible CSI feedback mode. For example, if the UE reports index #0 as a CSI feedback mode, the base station may identify that the CSI feedback mode supported by the UE is a legacy codebook-based feedback mode.

According to an embodiment, if the UE supports an AI model or AI-based CSI feedback (e.g., if the UE is an AI-enabled UE), the UE may report whether the UE supports an AI compression-based CSI feedback mode or an AI compression-based channel variation feedback mode. For example, if the UE reports index #1 (e.g., support of CSI compression) as a CSI feedback mode, the base station may identify that the CSI feedback mode supported by the UE is a feedback mode according to CSI compression based on an autoencoder. Alternatively, if the UE reports index #2 (e.g., support of CVF) as a CSI feedback mode, the base station may identify that the CSI feedback mode supported by the UE is a feedback mode according to compression of channel variation information as well as CSI compression based on an autoencoder.

According to various embodiments, the above feedback mode reported by the UE may be transmitted through RRC signaling through a higher layer as well as uplink control information (UCI) of 2 bits. For example, if AI-based CSI compression is supported, the UE may report whether the UE supports CVF, by transferring information according to Channel VariationFeedback={on, off; to the base station.

In addition, according to an embodiment, the UE may report, to the base station, a possible mode among existing pre-defined CSI feedback modes. For example, the UE may report multiple possible feedback modes, and based on the index, etc. in Table 1 above, if the UE is unable to use AI-based feedback, the UE may report information including a form of UE={0}, and if the UE is able to use AI-based CVF, the UE may report information including a form of UE={1, 2}.

According to various embodiments, the CVF capability information reported by the UE may include capability information on a CVF model trained by the UE. Here, the CVF capability information may include at least one of UE-capable (trained) variation intervals or a UE-capable (trained) number of feedback bits. Referring to FIG. 10, in a separate training situation of an AI model, the UE trains the AI model without receiving a separate indication from the base station and thus the UE may select a CVF period for training or bits required for CVF. Therefore, the base station may need information relating to training performed by the UE for subsequent CSI feedback or UE scheduling.

According to an embodiment, the UE-capable trained variation interval may indicate a period between adjacent CSI. A unit of a period between CSI may include a slot, ms, or a time unit defined in a standard specification. For example, the UE may directly report, to the base station, a period of CSI measured by the UE to train an AI model. Alternatively, the period may be simply pre-defined to be a long interval (e.g., in a case of a low-speed scenario) or a short interval (e.g., in a case of a high-speed scenario), and in this case, the UE may indicate, to the base station, whether to perform training with each interval by using a bitmap or UCL

According to an embodiment, the UE-capable trained number of feedback bits may indicate the number of bits used by the UE when compressing a channel variation value. When a compressed channel variation is fed back, bits for a channel variation value may be transmitted through a physical uplink control channel (PUCCH) or a physical uplink shared channel (PUSCH). According to an embodiment, the number of feedback bits required by the UE in a low-speed scenario may be small, or the number of feedback bits required by the UE in a high-speed scenario may be large. In addition, according to an embodiment, a degree of training of an AI model included in the UE may vary according to the computation capability or hardware of the AI model. In addition, according to the performance of such training, a CSI compression ratio of the UE may vary. Therefore, the UE may need to report, to the base station, how many feedback bits the UE uses when compressing CSI or a channel variation, according to the capacity or capability of the UE. In this case, the UE may directly report a corresponding bit or may report a bit supportable by the UE among pre-defined bits. According to an embodiment, the number of feedback bits described above may be pre-defined in a form of a table, and in this case, the UE may directly report a form of capable feedback bits={100, 200} to the base station.

In operation 1010, the base station may transmit a CSI feedback configuration to the UE. The CSI feedback configuration transmitted by the base station may include at least one of a CSI feedback mode indicator or a feedback parameter configuration, or the above two piece of information may be transferred through separate pieces of information.

According to various embodiments, the base station may configure a CSI feedback mode to be actually used by the UE. The base station may indicate a CSI feedback mode to be actually used by the UE, based on a supportable feedback mode reported by the UE. According to an embodiment, the base station may configure the highest-level feedback mode among feedback modes usable by both of the UE and the base station.

According to an embodiment, the base station may, according to a future communication environment, semi-persistently or aperiodically change a feedback mode (e.g., by using a medium access control (MAC) control element (CE) or downlink control information (DCI). For example, the base station may selectively configure a dynamic CSI feedback mode by considering a system environment. Below, Table 2 shows an example of the CSI feedback modes configured by the base station for the UE according to a system environment.

TABLE 2

| System environment | NW's configuration type |
|---|---|
| When channel variation is relatively small | CVF mode: {2} |
| due to short CSI-RS periodicity | |
| When channel variation is relatively large | Mode including no CVF: {0}, |
| due to long CSI-RS periodicity | {1}, {0,1} |
| When channel variation is small due to | CVF mode: {2} |
| long channel coherence time in case of | |
| low-mobility UE | |
| When channel variation is large due to | Mode including no CVF: {0}, |
| short channel coherence time in case of | {1}, {0, 1} |
| high-speed UE | |
| When reduction of feedback overhead is | Mode including AI-enabled |
| required due to limited feedback resources | compression: |
| (i.e., PUCCH) if the number of RRC- | {1}, {2}, {1, 2} |
| connected UEs increases | |

Referring to Table 2, the base station may configure a feedback mode for the UE according to various system environments, and in this case, an index-specific CSI feedback mode defined in Table 1 may be indicated. For example, in an environment where a CSI-RS period is short and thus channel variation is relatively small, the base station may configure or indicate, for or to the UE, mode {2} that is a CVF mode for performing channel variation compression. Alternatively, in an environment where a CSI period is long and thus channel variation is relatively large, the base station may configure or indicate, for or to the UE, mode {0}, {1}, or {0, 1} that is a mode including no CVF mode so that the UE does not perform channel variation compression. Alternatively, in an environment where a UE moving at low speed has a long channel coherence time and thus channel variation is small, the base station may configure or indicate, for or to the UE, mode {2} that is a CVF mode for performing channel variation compression. Alternatively, in an environment where a UE moving at high speed has a short channel coherence time and thus channel variation is large, the base station may configure or indicate, for or to the UE, mode {0}, {1}, or {0, 1} that is a mode including no CVF mode so that the UE does not perform channel variation compression. Alternatively, if the number of UEs connected to the base station is large, by considering limited feedback resources and feedback overhead, the base station may configure or indicate, for or to a UE, mode {1}, {2}, or {1, 2} that is a CSI compression mode so that the UE performs AI-based CSI/channel variation compression. The system environment of the base station considered by the base station described above may be classified based on time domain channel property (TDCP) or positioning.

According to various embodiments, the base station may configure a feedback parameter for the UE. In this case, a period for CSI-RS transmission may be configured in advance.

According to an embodiment, the feedback parameter configured by the base station may include a period for performing channel variation feedback by the UE. According to an embodiment, the number of periods for performing channel variation feedback may be determined from a UE-capable number of CVFs in the CVF capability information of the UE.

According to an embodiment, the feedback parameter configured by the base station may include at least one of the number of feedback bits used by the UE for spatial area compression or the number of feedback bits used for channel variation compression. For example, the base station may allocate different numbers of bits to compression of CSI itself and compression of CSI channel variation, and this may be caused by the difference between information amounts. In general, the information amount of channel variation is smaller than that of CSI itself, and thus the UE may compress channel variation information by using less bits. According to an embodiment, the base station may explicitly indicate the number of bits to be used by the UE for compression or feedback, or may indicate an AI model when a number of bits required for each of particular AI models is defined in advance. According to various embodiments, the above configuration merely corresponds to an example, a feedback parameter may be defined in a pre-defined table form according to a combination, and in this case, the base station may indicate the index of a corresponding combination to configure a feedback parameter.

Hereinafter, operations may proceed identically or similarly to the procedure illustrated in FIG. 8.

In operation 1015, the base station may transmit a CSI-RS to the UE. More specifically, the base station may transmit CSI-RS #0 corresponding to a particular time point to the UE. According to an embodiment, CSI-RS #0 transmitted by the base station at the corresponding time point may be, hereinafter, used as a reference point for channel variation feedback (CVF) at a future time point. The CSI-RS transmitted by the base station is a reference signal for channel state reporting and may include a reference signal defined in a standard specification.

In operation 1020, the UE may perform AI-based CSI compression. More specifically, the UE may determine channel state information, based on CSI-RS #0 received from the base station and compress an eigenvector relating to the channel state information by using an AI encoder. The UE may obtain the latent vector z as compressed CSI information. Specific content for CSI compression may be based on the above description.

In operation 1025, the UE may transmit CSI feedback to the base station. More specifically, the UE may report the compressed CSI information (e.g., the latent vector z) to the base station.

In operation 1030, the base station may reconstruct AI-based CSI. More specifically, the base station may restore the compressed CSI information received from the UE to the CSI having been determined by the UE, by using an AI decoder.

In operation 1035, the base station may transmit a CSI-RS to the UE at a time point different from before. More specifically, the base station may transmit, to the UE, CSI-RS #n corresponding to the time point different from that of operation 1015. The CSI-RS transmitted by the base station is a reference signal for channel state reporting and may include a reference signal defined in a standard specification.

In operation 1040, the UE may perform AI-based CSI variation compression. More specifically, the UE may determine channel state information, based on CSI-RS #n received from the base station and compare same with a channel state based on CSI-RS #0 obtained at the previous time point, to determine a channel variation value. The UE may compress an eigenvector relating to the obtained channel variation value by using the AI encoder. The UE may obtain the latent vector z as compressed channel variation information.

In operation 1045, the UE may transmit channel variation feedback to the base station. More specifically, the UE may report the compressed channel variation information (e.g., the latent vector z) to the base station.

In operation 1050, the base station may reconstruct AI-based CSI. More specifically, the base station may process, as an input of the AI decoder, the compressed channel variation information received from the UE in operation 1045 together with the CSI information having been previously obtained at the previous time point (e.g., the information includes both CSI information having not been decoded for compression yet and CSI information having been decoded and restored), so as to restore the CSI at the corresponding time point.

According to various embodiments, operation 1035 to operation 1050 may be repeated one or more times, and may be performed only for some of CSI-RSs periodically transmitted by the base station. For example, between operation 1030 and operation 1035, although not illustrated, at least one (AI-based or legacy-based) CSI-RS feedback/channel variation feedback process between the UE and the base station may be included or omitted.

Hereinafter, various embodiments according to training of an AI model used by a UE and a base station and the subject of training will be described in detail. According to various embodiments, as described above, a AI-CVF method may employ two autoencoders. A transformer model may be used for example as an AI backbone for extracting a SF domain correlation of Vₚ₋₁ and a temporal variation of Vₚ₋₁−Vₚ. In general, a transformer model may computes the cross-covariance between input sequences and then update an input according to the magnitude of the covariance. In the disclosure, Ns subbands may be considered as input sequences indicating an Nₜ spatial area property (feature) as a dimension. Therefore, by using the covariance between Nₜ-dimensional Ns subbands, an SF domain channel property and a channel variation property may be obtained. According to various embodiments, in order to perform an operation according to an autoencoder and an AI model, a UE and a base station may perform training through an AI model operation described above, and this will be described in detail.

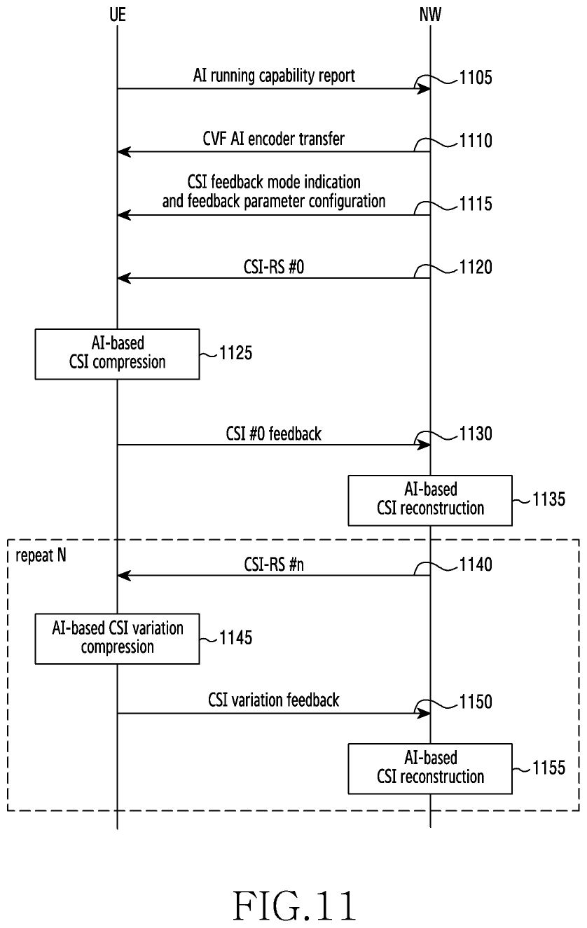

FIG. 11 illustrates a flow of a signal for compressing and reporting a CSI variation, based on an AI model trained by a base station according to an embodiment of the disclosure. More specifically, referring to FIG. 11, a CVF procedure (e.g., network (NW)-based model transfer) based on a model trained by a base station is illustrated.

In operation 1105, a UE may transmit AI operation (running) capability information to a base station. For example, the base station may train an encoder used by the UE and thus the UE needs to receive a trained model from the base station. Therefore, to this end, first, the UE may report an AI operation capability for receiving a trained model from the base station. According to the AI operation capability transmitted by the UE, the base station may select a proper trained model to be used by the UE.

According to various embodiments, the AI operation capability information transmitted by the UE may indicate a UE capability type. Here, the UE capability type may include at least one of information (e.g., non-AI or AI) on whether AI is supported according to the degree of UE implementation, AI computing-related capability information (e.g., AI operation power consumption, available power for AI inference, battery state, AI operation floating point operations per second (FLOPS), input/output (I/O) memory bandwidth, etc.), or AI model-related capability information (e.g., neural processing unit (NPU)/tensor processing unit (TPU) memory, number of parameters, model storage space, and quantization type).

According to an embodiment, the UE may explicitly indicate a UE capability type. Alternatively, the above capability types may be defined in a form of Table 3 below and the UE may transmit the index of a corresponding category to the base station.

TABLE 3

| Category index | Quantization type | FLOPS | AI memory (MB) |
|---|---|---|---|
| Category 0 | INT8 | 10⁶ | 100 |
| Category 1 | INT8 | 10⁷ | |
| Category 2 | FLOAT16 | 10⁸ | 200 |
| Category 3 | FLOAT16 | 10⁹ | |

In operation 1110, the base station may transfer a CVF AI encoder to the UE. More specifically, the base station may transfer, to the UE, a trained encoder (or AI model) used for a CVF compression/restoration operation, based on the AI operation capability reported by the UE.

According to various embodiments, AI model transfer may include transfer of a model backbone and transfer of a model weight. The backbone is the architecture of the model and may include a CNN, an LSTM, a transformer, etc., and the weight may include a parameter value applied to the model. Below, Table 4 shows an example of the backbone indicated by the base station.

TABLE 4

| Layer | Type | Filter | Output Shape |
|---|---|---|---|
| Input 1: \hat{V}ₚ₋₁ ∈ [symbol] | reconstructed CSI | — | [B, Nₛ, Nₜ] |
| Input 2: z_{Δ}_{ₚ} ∈ [symbol] | variation vector | — | [B, Nₛ, F] |
| Real input | concatenate | — | [B, Nₛ, 2(Nₜ + F)] |
| CNN block 1 | 2D convolution | (3, 3) | [B, Nₛ, 2(Nₜ + F)] |
| CNN block 2 | 2D convolution | (3, 3) | [B, Nₛ, 2Nₜ] |
| Output | reconstructed CSI | — | [B, Nₛ, Nₜ] |

According to an embodiment, if an AI model-related backbone and a weight are pre-defined, the base station may indicate a pair to be used among particular backbone-weight pairs by considering the AI operation capability of the UE.

According to an embodiment, if an AI model-related backbone is pre-defined but a weight is not defined, the base station may indicate a corresponding backbone among CVF AI models (e.g., backbones supported by the UE) defined according to the AI operation capability information of the UE, and may transfer the value of a weight trained with by the base station together.

According to an embodiment, if an AI model-related backbone and a weight are not defined in advance, the base station may define a backbone and a weight according to the AI operation capability information of the UE and transfer an AI model configured thereby to the UE. The AI model transferred by the base station may be transferred in a model representation format (MRF) usable by the UE. Alternatively, the model may be configured by a binary operation (running) format or may be transferred through RRC signaling.

Hereinafter, operations may proceed identically or similarly to the procedure illustrated in FIG. 10.

In operation 1115, the base station may transmit a CSI feedback configuration to the UE. The CSI feedback configuration transmitted by the base station may include at least one of a CSI feedback mode indicator or a feedback parameter configuration, or the above two piece of information may be transferred through separate pieces of information. Operation 1115 may proceed identically or similarly to operation 1010 in FIG. 10 and to this end, first, although not illustrated in FIG. 11, an operation corresponding to operation 1005 in FIG. 10 may be performed.

In operation 1120, the base station may transmit a CSI-RS to the UE. More specifically, the base station may transmit CSI-RS #0 corresponding to a particular time point to the UE. According to an embodiment, CSI-RS #0 transmitted by the base station at the corresponding time point may be, hereinafter, used as a reference point for channel variation feedback (CVF) at a future time point. The CSI-RS transmitted by the base station is a reference signal for channel state reporting and may include a reference signal defined in a standard specification.

In operation 1125, the UE may perform AI-based CSI compression. More specifically, the UE may determine channel state information, based on CSI-RS #0 received from the base station and compress an eigenvector relating to the channel state information by using an AI encoder. The UE may obtain the latent vector z as compressed CSI information. Specific content for CSI compression may be based on the above description.

In operation 1130, the UE may transmit CSI feedback to the base station. More specifically, the UE may report the compressed CSI information (e.g., the latent vector z) to the base station.

In operation 1135, the base station may reconstruct AI-based CSI. More specifically, the base station may restore the compressed CSI information received from the UE to the CSI having been determined by the UE, by using an AI decoder.

In operation 1140, the base station may transmit a CSI-RS to the UE at a time point different from before. More specifically, the base station may transmit, to the UE, CSI-RS #n corresponding to the time point different from that of operation 1120. The CSI-RS transmitted by the base station is a reference signal for channel state reporting and may include a reference signal defined in a standard specification.

In operation 1145, the UE may perform AI-based CSI variation compression. More specifically, the UE may determine channel state information, based on CSI-RS #n received from the base station and compare same with a channel state based on CSI-RS #0 obtained at the previous time point, to determine a channel variation value. The UE may compress an eigenvector relating to the obtained channel variation value by using the AI encoder. The UE may obtain the latent vector z as compressed channel variation information.

In operation 1150, the UE may transmit channel variation feedback to the base station. More specifically, the UE may report the compressed channel variation information (e.g., the latent vector z) to the base station.

In operation 1155, the base station may reconstruct AI-based CSI. More specifically, the base station may process, as an input of the AI decoder, the compressed channel variation information received from the UE in operation 1150 together with the CSI information having been previously obtained at the previous time point (e.g., the information includes both CSI information having not been decoded for compression yet and CSI information having been decoded and restored), so as to restore the CSI at the corresponding time point.

According to various embodiments, operation 1140 to operation 1155 may be repeated one or more times, and may be performed only for some of CSI-RSs periodically transmitted by the base station. For example, between operation 1135 and operation 1140, although not illustrated, at least one (AI-based or legacy-based) CSI-RS feedback/channel variation feedback process between the UE and the base station may be included or omitted.

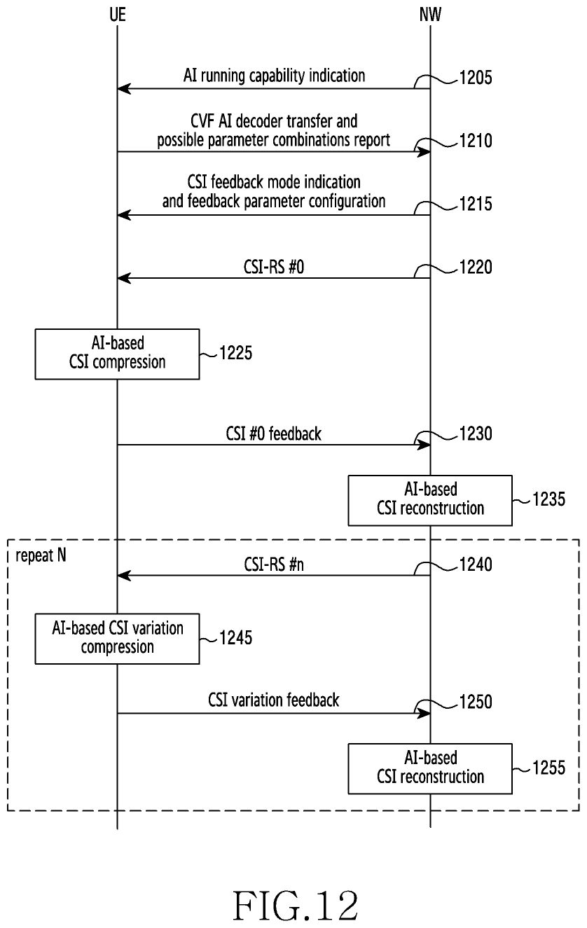

FIG. 12 illustrates a flow of a signal for compressing and reporting a CSI variation, based on an AI model trained by a UE according to an embodiment of the disclosure. More specifically, referring to FIG. 12, a CVF procedure (e.g., UE-driven model transfer) based on a model trained by a UE is illustrated.

In operation 1205, a base station may transmit UE operation capability information to a UE. For example, the UE may train a decoder used by the base station and thus the base station needs to receive a trained model from the UE. Therefore, to this end, first, the base station may report an AI operation capability for receiving a trained model from the UE. According to the AI operation capability transmitted by the base station, the UE may select a proper trained model to be used by the base station. According to various embodiments, operation 1205 may proceed similarly to operation 1105 in FIG. 11 except that only the considered subject of a AI operation capability, the subject of training, and the subject of AI model transfer are different. However, in general, the base station may have larger calculation complexity, spatial complexity, etc., compared to the UE, and thus table values for capability information may differ.

In operation 1210, the UE may transfer a CVF AI decoder to the base station and report combinations of possible parameters. More specifically, the UE may transfer, to the base station, a trained decoder (or AI model) used for a CVF compression/restoration operation, based on the AI operation capability reported by the base station. In addition, the UE may report a parameter combination for the trained model. For example, the parameter combination reported by the UE may include a CVF period for the trained model, information on feedback bits used for channel variation combination, or the like.

According to an embodiment, if an AI model-related backbone and a weight are pre-defined, the UE may indicate a pair to be used among particular backbone-weight pairs by considering the AI operation capability of the base station. The decoder transferred by the UE is selected from among the defined backbone-weight pairs, and thus a CVF parameter may also be defined in advance. Therefore, the base station may have consistency for the CVF parameter.

According to an embodiment, if an AI model-related backbone is pre-defined but a weight is not defined, the UE may indicate a corresponding backbone among CVF AI models (e.g., backbones supported by the UE) defined according to the AI operation capability information of the base station, and may transfer the value of a weight trained with by the UE together. If a CVF parameter is defined together with the backbone, the base station may receive a decoder to have consistency for the CVF parameter. However, if a CVF parameter is not defined, the UE may report CVF parameters (e.g., a period for channel variation) having been used for training the model together.

According to an embodiment, if an AI model-related backbone and a weight are not defined in advance, the UE may define a backbone and a weight according to the AI operation capability information of the base station and transfer an AI model configured thereby to the base station. The AI model transferred by the UE may be transferred in a model representation format (MRF) usable by the base station. Alternatively, the model may be configured by a binary operation (running) format or may be transferred through RRC signaling. In this case, the UE may report CVF parameters (e.g., a period for channel variation) having been used for training the model together.

Hereinafter, operations may proceed identically or similarly to the procedure illustrated in FIG. 11.

In operation 1215, the base station may transmit a CSI feedback configuration to the UE. The CSI feedback configuration transmitted by the base station may include at least one of a CSI feedback mode indicator or a feedback parameter configuration, or the above two piece of information may be transferred through separate pieces of information. Operation 1215 may proceed identically or similarly to operation 1010 in FIG. 10 or operation 1115 in FIG. 11 and to this end, first, although not illustrated in FIG. 12, an operation corresponding to operation 1005 in FIG. 10 may be performed.

In operation 1220, the base station may transmit a CSI-RS to the UE. More specifically, the base station may transmit CSI-RS #0 corresponding to a particular time point to the UE. According to an embodiment, CSI-RS #0 transmitted by the base station at the corresponding time point may be, hereinafter, used as a reference point for channel variation feedback (CVF) at a future time point. The CSI-RS transmitted by the base station is a reference signal for channel state reporting and may include a reference signal defined in a standard specification.

In operation 1225, the UE may perform AI-based CSI compression. More specifically, the UE may determine channel state information, based on CSI-RS #0 received from the base station and compress an eigenvector relating to the channel state information by using an AI encoder. The UE may obtain the latent vector z as compressed CSI information. Specific content for CSI compression may be based on the above description.

In operation 1230, the UE may transmit CSI feedback to the base station. More specifically, the UE may report the compressed CSI information (e.g., the latent vector z) to the base station.

In operation 1235, the base station may reconstruct AI-based CSI. More specifically, the base station may restore the compressed CSI information received from the UE to the CSI having been determined by the UE, by using an AI decoder.

In operation 1240, the base station may transmit a CSI-RS to the UE at a time point different from before. More specifically, the base station may transmit, to the UE, CSI-RS #n corresponding to the time point different from that of operation 1220. The CSI-RS transmitted by the base station is a reference signal for channel state reporting and may include a reference signal defined in a standard specification. In operation 1245, the UE may perform AI-based CSI variation compression. More specifically, the UE may determine channel state information, based on CSI-RS #n received from the base station and compare same with a channel state based on CSI-RS #0 obtained at the previous time point, to determine a channel variation value. The UE may compress an eigenvector relating to the obtained channel variation value by using the AI encoder. The UE may obtain the latent vector z as compressed channel variation information.

In operation 1250, the UE may transmit channel variation feedback to the base station. More specifically, the UE may report the compressed channel variation information (e.g., the latent vector z) to the base station.

In operation 1255, the base station may reconstruct AI-based CSI. More specifically, the base station may process, as an input of the AI decoder, the compressed channel variation information received from the UE in operation 1250 together with the CSI information having been previously obtained at the previous time point (e.g., the information includes both CSI information having not been decoded for compression yet and CSI information having been decoded and restored), so as to restore the CSI at the corresponding time point.

According to various embodiments, operation 1240 to operation 1255 may be repeated one or more times, and may be performed only for some of CSI-RSs periodically transmitted by the base station. For example, between operation 1235 and operation 1240, although not illustrated, at least one (AI-based or legacy-based) CSI-RS feedback/channel variation feedback process between the UE and the base station may be included or omitted.

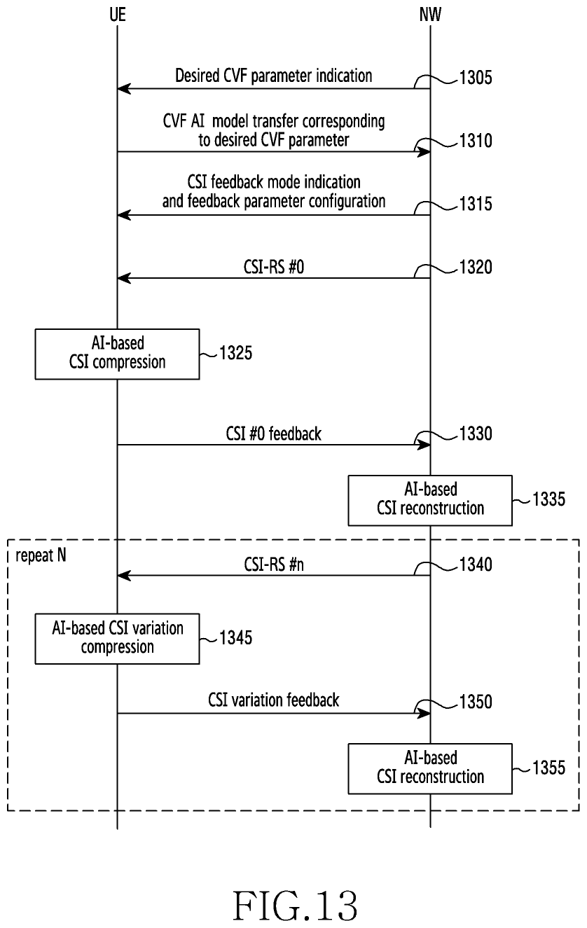

FIG. 13 illustrates a flow of a signal for compressing and reporting a CSI variation, based on an AI model trained by a UE according to a preference of a base station according to an embodiment of the disclosure. More specifically, referring to FIG. 13, a procedure for indicating, by a base station, a CVF parameter to be used to a UE first, and transferring, by the UE, an AI decoder corresponding to the indicated CVF parameter to the base station is illustrated.

In operation 1305, a base station may indicate a preferred CVF parameter to a UE for CVF. For example, the base station may determine a CSI-RS period or a CSI reporting period, based on traffic load, scheduling information, etc., or may determine the number of feedback bits, based on PUCCH available resources, the number of serving UEs, etc. According to an embodiment, the base station may indicate a preferred CVF parameter, based on a pre-defined CVF parameter combination table. Below, Table 5 shows an example of a pre-defined CVF parameter combination.

TABLE 5

| | | |
|---|---|---|
| Parameter | Period | Feedback bits |

| combination | for CVF | | SF compression | CV compression |
|---|---|---|---|---|
| 1 | 5 | ms | 100 | 20 |
| 2 | 10 | ms | 100 | 40 |
| 3 | 10 | ms | 200 | 20 |
| 4 | 15 | ms | 200 | 40 |
| 5 | 20 | ms | 300 | 20 |

According to an embodiment, the base station may indicate, to the UE, an index corresponding to a combination to be used among the parameter combinations in Table 5 above. According to various embodiments, Table 5 above is not limited to an operation in FIG. 13 and may be applied to a feedback parameter configuration operation in operation 1010 in FIG. 10, operation 1115 in FIG. 11, and operation 1215 in FIG. 12. However, the above indication operation merely corresponds to an example, and according to various embodiments, the base station may indicate a CVF parameter itself to the UE through RRC signaling, etc.

In operation 1310, the UE may transfer, to the base station, a CVF AI decoder corresponding to the CVF parameter indicated by the base station. If there is no AI model corresponding to a CVF parameter combination preferred by the base station, the UE may report possible parameter combinations to the base station together with a trained AI decoder. Operation 1310 or reporting of possible parameter combinations may proceed identically or similarly to the operation described in operation 1210 in FIG. 12. Thereafter, the base station may configure or indicate a CVF parameter to be used, based on the possible parameter combinations of the UE. According to various embodiments, although not illustrated in FIG. 13, the base station may transmit AI operation capability information to the UE first, and thus an operation identical or similar to operation 1205 in FIG. 12 may proceed.

Hereinafter, operations may proceed identically or similarly to the procedure illustrated in FIG. 12.

In operation 1315, the base station may transmit a CSI feedback configuration to the UE. The CSI feedback configuration transmitted by the base station may include at least one of a CSI feedback mode indicator or a feedback parameter configuration, or the above two piece of information may be transferred through separate pieces of information. Operation 1315 may proceed identically or similarly to operation 1010 in FIG. 10, operation 1115 in FIG. 11, or operation 1215 in FIG. 12, and to this end, first, although not illustrated in FIG. 13, an operation corresponding to operation 1005 in FIG. 10 may be performed.

In operation 1320, the base station may transmit a CSI-RS to the UE. More specifically, the base station may transmit CSI-RS #0 corresponding to a particular time point to the UE. According to an embodiment, CSI-RS #0 transmitted by the base station at the corresponding time point may be, hereinafter, used as a reference point for channel variation feedback (CVF) at a future time point. The CSI-RS transmitted by the base station is a reference signal for channel state reporting and may include a reference signal defined in a standard specification.

In operation 1325, the UE may perform AI-based CSI compression. More specifically, the UE may determine channel state information, based on CSI-RS #0 received from the base station and compress an eigenvector relating to the channel state information by using an AI encoder. The UE may obtain the latent vector z as compressed CSI information. Specific content for CSI compression may be based on the above description.

In operation 1330, the UE may transmit CSI feedback to the base station. More specifically, the UE may report the compressed CSI information (e.g., the latent vector z) to the base station.

In operation 1335, the base station may reconstruct AI-based CSI. More specifically, the base station may restore the compressed CSI information received from the UE to the CSI having been determined by the UE, by using an AI decoder.

In operation 1340, the base station may transmit a CSI-RS to the UE at a time point different from before. More specifically, the base station may transmit, to the UE, CSI-RS #n corresponding to the time point different from that of operation 1320. The CSI-RS transmitted by the base station is a reference signal for channel state reporting and may include a reference signal defined in a standard specification.

In operation 1345, the UE may perform AI-based CSI variation compression. More specifically, the UE may determine channel state information, based on CSI-RS #n received from the base station and compare same with a channel state based on CSI-RS #0 obtained at the previous time point, to determine a channel variation value. The UE may compress an eigenvector relating to the obtained channel variation value by using the AI encoder. The UE may obtain the latent vector z as compressed channel variation information.

In operation 1350, the UE may transmit channel variation feedback to the base station. More specifically, the UE may report the compressed channel variation information (e.g., the latent vector z) to the base station.

In operation 1355, the base station may reconstruct AI-based CSI. More specifically, the base station may process, as an input of the AI decoder, the compressed channel variation information received from the UE in operation 1350 together with the CSI information having been previously obtained at the previous time point (e.g., the information includes both CSI information having not been decoded for compression yet and CSI information having been decoded and restored), so as to restore the CSI at the corresponding time point.

According to various embodiments, operation 1340 to operation 1355 may be repeated one or more times, and may be performed only for some of CSI-RSs periodically transmitted by the base station. For example, between operation 1335 and operation 1340, although not illustrated, at least one (AI-based or legacy-based) CSI-RS feedback/channel variation feedback process between the UE and the base station may be included or omitted.

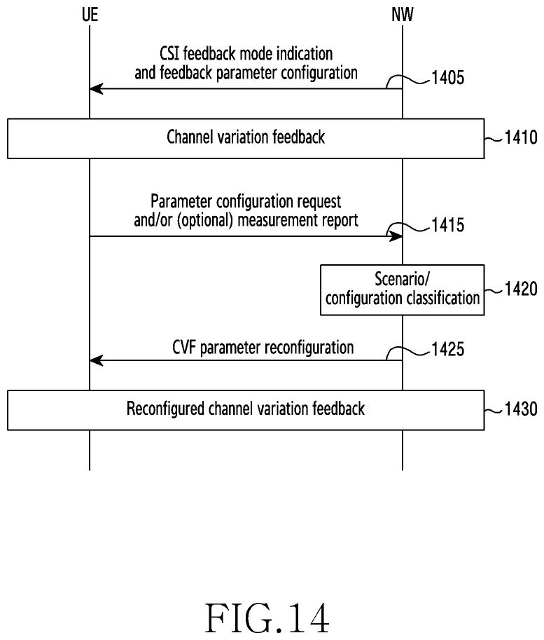

FIG. 14 illustrates a flow of a signal for reconfiguring a parameter for CSI compression according to an embodiment of the disclosure. More specifically, FIG. 14 illustrates a flow of a signal for reconfiguring a CVF parameter for compressing and reporting a CSI variation.

More specifically, referring to FIG. 14, a UE may request a base station to reconfigure a CVF parameter or report a CVF-related measurement result to the base station. The base station may reconfigure a CVF parameter for the UE through a channel environment determined by the base station itself or a reported measurement result of the UE. The UE and the base station may perform CVF by using the reconfigured CVF parameter.

In operation 1405 and operation 1410, a base station and a UE may perform CVF by using an initially configured CVF parameter. Parameter configuration in operation 1405 and CVF performing using same in operation 1410 may proceed identically or similarly to the procedures illustrated in FIG. 8 and FIG. 10 to FIG. 13.

In operation 1415, the UE may transmit a request for CVF parameter reconfiguration to the base station. According to an embodiment, the UE may determine a performance deterioration of a CVF AI model, based on a channel measured for CVF, or determine a CVF performance deterioration through a channel state determination algorithm of the UE. If a CVF performance deterioration is determined, the UE may request the base station to reconfigure the CVF parameter. For example, the request transmitted by the UE may be transmitted through UCI of 1 bit. The UE may also report a measurement result, such as a performance monitoring result related to CVF, to the base station as well as the 1-bit parameter reconfiguration request. For example, when the UE reports a performance monitoring result related to CVF, the reported performance may include the square of generalized cosine similarity (SGCS) of the predicted channel, the mean square error (MSE) of the predicted channel, etc.

In operation 1420, the base station may determine a CVF performance deterioration through a channel state determination algorithm of the base station. According to an embodiment, the performance deterioration determination operation, the base station may also use the CVF performance monitoring result of the UE or an existing measurement result (e.g., time-domain channel property (TDCP) or positioning result) in addition to the channel state determination algorithm of the base station.

In operation 1425, the base station may transmit a reconfigured CVF parameter to the UE. The reconfigured CVF parameter may include at least one of the parameter combinations in Table 5 above. For example, the base station may indicate, to the UE, an index corresponding to a combination desired to be reconfigured among the parameter combinations. However, the above indication operation merely corresponds to an example, and according to various embodiments, the base station may indicate a CVF parameter itself to the UE through RRC signaling, etc.

In operation 1430, the base station and the UE may perform CVF, based on the reconfigured CVF parameter. For example, operation 1430 and subsequent operations may proceed identically or similarly to the procedures illustrated in FIG. 8 and FIG. 10 to FIG. 13.

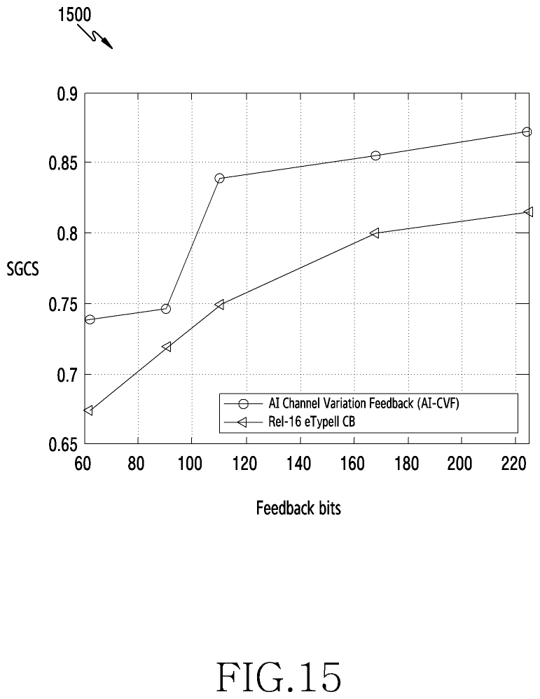

FIG. 15 illustrates an effect according to CSI variation compression and reporting based on an AI model in comparison with codebook-based CSI reporting according to an embodiment of the disclosure. More specifically, FIG. 15 illustrates a performance result 1500 of an AI-CVF method according to the disclosure in a rank 1 transmission environment where Nₜ=32, Nᵣ=4, Nₛ=13, N_{RB}, and T_{CSI}=4 ms are configured and a single eigenvector is fed back. In addition, in FIG. 15, two pieces of CSI are considered as a single feedback pair, a first piece of CSI is fed back by an SF domain autoencoder, and a second piece of CSI may be restored by a channel variation autoencoder.

As a result value for performance, the vertical axis represents the square of generalized cosine similarity (SGCS), which is defined as the square of the inner product between an actual eigenvector and a restored vector, and the horizontal axis represents the number of feedback bits. More specifically, SGCS may be represented by the following equation.

$$S G C S = \frac{1}{N} {\sum }_{i = 1}^{{N}_{S B}} {( \frac{\vert {\tilde{v}}_{i}^{H} {v}_{i} \vert}{‖ {\tilde{v}}_{i} ‖ ‖ {v}_{i} ‖} )}^{2} = \frac{1}{N} {\sum }_{i = 1}^{{N}_{S B}} {cos}^{2} {θ}_{i} \qquad Equation 1$$

Referring to FIG. 15, a CVF method according to the disclosure may have more superior performance compared to enhanced type II codebook (eType II CB) of Rel-16 that is a conventional CSI transmission method. For example, the CVF method may achieve approximately 12% gain compared to eType II CB and may require only significantly fewer feedback bits. For example, based on SGCS=0.81, the number of feedback bits required by the CVF method according to the disclosure may be reduced by approximately 52.3% compared to the number of bits required by the conventional CSI method.

As described above, the disclosure proposes a novel CSI feedback method that improves feedback accuracy to enhance cell throughput, and to this end, proposes a hybrid AI model including an SF domain autoencoder and a channel variation autoencoder. According to the aforementioned numerical simulation, the AI-CVF method may improve CSI feedback accuracy by 14% without increasing computational complexity. Based on the improved CSI quality, cell throughput and multi-user coverage may be significantly enhanced. Furthermore, AI-CVF may also solve the excessive feedback overhead in X-MIMO systems.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and equivalents.

What is claimed is:

1. A user equipment (UE) in a wireless communication system, the UE comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the UE to:
receive, from a base station, a first channel state information (CSI)-reference signal (RS) at a first time,
perform artificial intelligence (AI)-based CSI compression, based on the first CSI-RS,
transmit, to the base station, first feedback according to the AI-based CSI compression,
receive, from the base station a second CSI-RS at a second time,
perform AI-based CSI variation compression, based on a variation value between the second CSI-RS and the first CSI-RS, and
transmit, from the base station, second feedback according to the AI-based CSI variation compression.

2. The UE of claim 1, wherein the computer-executable instructions, when executed by the one or more processors individually or collectively, further cause the UE to:
transmit, to the base station, capability information on a CSI feedback mode supported by the UE; and
receive, from the base station, configuration information for configuring an indicator indicating a CSI feedback mode performed by the UE.

3. The UE of claim 2,
wherein the configuration information includes at least one of information on a period for reporting CSI variation or information on the number of bits for reporting the CSI variation, and
wherein the CSI feedback mode performed by the UE indicates at least one of a mode not supporting compression according to AI, a mode supporting feedback based on compression according to AI, or a mode supporting feedback based on variation compression according to AI.

4. The UE of claim 1,
wherein the computer-executable instructions, when executed by the one or more processors individually or collectively, further cause the UE to receive, from the base station, an AI model for the CSI variation compression, and
wherein the AI model includes at least one of a model backbone trained by the base station or a model weight.

5. The UE of claim 1,
wherein the computer-executable instructions, when executed by the one or more processors individually or collectively, further cause the UE to transmit, to the base station, an AI model for the CSI variation compression, and
wherein the AI model includes at least one of a model backbone trained by the UE or a model weight.

6. A base station in a wireless communication system, the base station comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the base station to:
transmit, to a user equipment (UE), a first channel state information (CSI)-reference signal (RS) at a first time,
receive, from the UE, first feedback obtained by performing artificial intelligence (AI)-based CSI compression based on the first CSI-RS,
transmit, to the UE, a second CSI-RS at a second time,
receive, from the UE, second feedback obtained by performing AI-based CSI variation compression, based on a variation value between the second CSI-RS and the first CSI-RS, and
perform CSI reconstruction, based on the first feedback and the second feedback.

7. The base station of claim 6, wherein the computer-executable instructions, when executed by the one or more processors individually or collectively, further cause the base station to:
receive, from UE, capability information on a CSI feedback mode supported by the UE; and
transmit, to the UE, configuration information for configuring an indicator indicating a CSI feedback mode performed by the UE.

8. The base station of claim 7,
wherein the configuration information includes at least one of information on a period for reporting CSI variation or information on the number of bits for reporting the CSI variation, and
wherein the CSI feedback mode performed by the UE indicates at least one of a mode not supporting compression according to AI, a mode supporting feedback based on compression according to AI, or a mode supporting feedback based on variation compression according to AI.

9. The base station of claim 6,
wherein the computer-executable instructions, when executed by the one or more processors individually or collectively, further cause the base station to transmit, to the UE, an AI model for the CSI variation compression, and
wherein the AI model includes at least one of a model backbone trained by the base station or a model weight.

10. The base station of claim 6,
wherein the computer-executable instructions, when executed by the one or more processors individually or collectively, further cause the base station to receive, from the UE, an AI model for the CSI variation compression, and
wherein the AI model includes at least one of a model backbone trained by the UE or a model weight.

11. A method performed by a user equipment (UE) in a wireless communication system, the method comprising:
receiving, from a base station, a first channel state information (CSI)-reference signal (RS) at a first time;
performing artificial intelligence (AI)-based CSI compression, based on the first CSI-RS;
transmitting, to the base station, first feedback according to the AI-based CSI compression;
receiving, from the base station, a second CSI-RS at a second time;
performing AI-based CSI variation compression, based on a variation value between the second CSI-RS and the first CSI-RS; and
transmitting, to the base station, second feedback according to the AI-based CSI variation compression.

12. The method of claim 11, further comprising:
transmitting, to the base station, capability information on a CSI feedback mode supported by the UE; and
receiving, from the base station, configuration information for configuring an indicator indicating a CSI feedback mode performed by the UE.

13. The method of claim 12,
wherein the configuration information includes at least one of information on a period for reporting CSI variation or information on the number of bits for reporting the CSI variation, and
wherein the CSI feedback mode performed by the UE indicates at least one of a mode not supporting compression according to AI, a mode supporting feedback based on compression according to AI, or a mode supporting feedback based on variation compression according to AI.

14. The method of claim 11, further comprising:
receiving, from the base station, an AI model for the CSI variation compression,
wherein the AI model includes at least one of a model backbone trained by the base station or a model weight.

15. The method of claim 11, further comprising:
transmitting, to the base station, an AI model for the CSI variation compression,
wherein the AI model includes at least one of a model backbone trained by UE or a model weight.

16. A method performed by a base station in a wireless communication system, the method comprising:
transmitting, to a user equipment (UE), a first channel state information (CSI)-reference signal (RS) at a first time;
receiving, from the UE, first feedback obtained by performing artificial intelligence (AI)-based CSI compression based on the first CSI-RS;
transmitting, to the UE, a second CSI-RS at a second time;
receiving, from the UE, second feedback obtained by performing AI-based CSI variation compression, based on a variation value between the second CSI-RS and the first CSI-RS; and
performing CSI reconstruction, based on the first feedback and the second feedback.

17. The method of claim 16, further comprising:
receiving, from the UE, capability information on a CSI feedback mode supported by the UE; and
transmitting, to the UE, configuration information for configuring an indicator indicating a CSI feedback mode performed by the UE.

18. The method of claim 17,
wherein the configuration information includes at least one of information on a period for reporting CSI variation or information on the number of bits for reporting the CSI variation, and
wherein the CSI feedback mode performed by the UE indicates at least one of a mode not supporting compression according to AI, a mode supporting feedback based on compression according to AI, or a mode supporting feedback based on variation compression according to AI.

19. The method of claim 16, further comprising:
transmitting, to the UE, an AI model for the CSI variation compression,
wherein the AI model includes at least one of a model backbone trained by the base station or a model weight.

20. The method of claim 16, further comprising receiving, from the UE, an AI model for the CSI variation compression,
wherein the AI model includes at least one of a model backbone trained by the UE or a model weight.
